(19) United States
(12) Patent Application Publication
(10) Pub. No.: US 2012/0170700 A1
(43) Pub. Date: Jul. 5, 2012

(54) Nuclear Fusion

(76) Inventor: Olivier Jean-Marie Rene Gorre, Sceaux (FR)

(21) Appl. No.: 12/980,430

(22) Filed: Dec. 29, 2010

(51) Int. Cl. G21B 1/11

(52) U.S. Cl. 376/107

(57) ABSTRACT

Our device realize nuclear (or proton) fusion in void thanks to 2 or more nuclear (or proton) beams.

Between 2 consecutive beams there is the same angle (and sum is 360°).

Beams' angles with horizontal plane are equal and small.

Beams' momentum are equal.

Like this, fusion products evacuate vertically from the fusion point.

Beams' speeds are well tuned not to produce new particles.

Our device can produce nuclear (or proton) fusion in void.

The idea is to give to matter particles enough kinetic energy (temperature) in the aim to produce fusion at a space point.

In this aim we create nuclear (or proton) beams that make fusion at one point (intersection of 2 or more beams according to needs).

Angle between beams must be equal (and sum must be 360°).

Beams' momentum must be equal.

The angles between each beam and horizontal plane are equal and small (because of particles' speed).

Like this, fusion products are evacuated vertically.

Electrostatic or electromagnetic fields can also help this.

In an industrial application, perhaps all nucleons or nucleus will not have merged (imperfect fusion).

So, the fusion nuclear products must be sort after cooling and after made atoms with electrons or by electromagnetic or electrostatic sorting.

Beams' angles with the horizontal plane is made with electrostatic or electromagnetic well tuned beams' deflectors.

Since beams' momentums are equal, density of particles in beams can be different according to beams' speed in the aim to make fusion more properly.

### BRIEF DESCRIPTION OF THE FIGURES

FIG. 1. The figure shows 2 beams that collide with an angle with horizontal plane of alpha degrees (small). Beams' speeds are well tuned according to beams' densities. Beams' momentums are equals. Products of fusion are evacuated on vertical line.

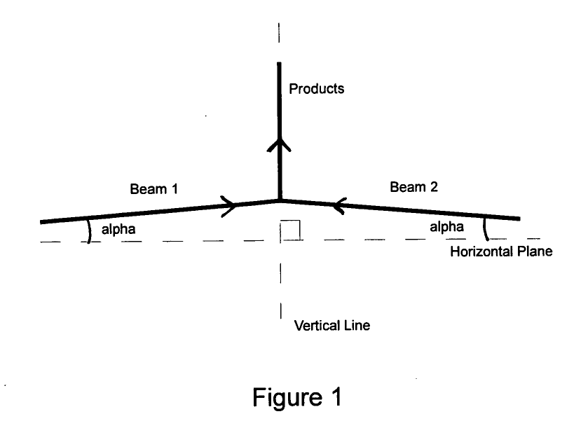

1) Nuclear fusion device of nuclear (or proton) beams in void with well tuned speeds and well tuned particles' density.
Beams' angles with the horizontal plane are equal.
Fusion products are evacuated vertically and naturally because particles' momentum are equal (and possibly with electrostatic or electromagnetic field).
Consecutive beams' angles are equal (and sum is 360°).

2) Energy production.

3) New matter production by nucleus (or proton) fusion.
